(19) United States
(12) Patent Application Publication
(10) Pub. No.: US 2007/0247271 A1
(43) Pub. Date: Oct. 25, 2007

(54) Low loss, high DC current inductor

(76) Inventors: Timothy M. Grupa, Golden Valley, MN (US); David E. Everett, Blaine, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/546,536

(22) Filed: Oct. 11, 2006

Related U.S. Application Data
(60) Provisional application No. 60/725,346, filed on Oct. 11, 2005.

(51) Int. Cl. H01F 7/06; H01F 27/28

(52) U.S. Cl. 336/223; 29/602.1; 336/222

(57) ABSTRACT

An inductor includes an inductor assembly having two coaxial, substantially linear windings axially disposed with respect to a plurality of toroidal magnetic cores. A method of forming an inductor is further included.

### RELATED APPLICATION

The present application claims the benefit of U.S. Provisional Application No. 60/725346, filed Oct. 11, 2005 and included herein by reference in its entirety.

### FIELD OF THE INVENTION

The present invention pertains in general to a current filtering device and, more particularly, to a high DC current inductor for use in common mode filtering applications.

### BACKGROUND OF THE INVENTION

Electronic equipment used in commercial and military applications must adhere to conducted emission requirements at the input power terminals of the electronic equipment. These requirements are levied on the electronic equipment manufacturers by agencies such as the FCC, European Union and, in the case of the U.S. Military, the procuring branch of the service. The goal of these requirements is to minimize the negative interactions that may occur between electronic equipment. The interactions occur because the noise currents, normally produced by switching action in one piece of electronic equipment, interfere with the proper operation of another piece of electronic equipment. Typically, the method of coupling is conduction through a common shared power bus (DC or AC). In other cases, the noise currents flowing on the power bus may set up electromagnetic interference (EMI) that couples into the surrounding electronic equipment via electromagnetic radiation. Noise currents are typically AC and have frequencies that are much greater than the operating frequency of the power source.

Noise currents can be characterized by the path that they take during conduction. Two conduction paths exist: Normal Mode (sometimes referred to as Differential Mode) and Common Mode.

Normal mode noise currents, Inm1 and Inm2 as shown in FIG. 1, flow into one input power terminal of the electronic equipment and exit from the remaining input power terminal(s). The sum of all the normal mode noise currents entering and exiting the electronic equipment input power terminals is zero.

In contrast, the sum of common mode noise currents, Icm1 and Icm2 as shown in FIG. 2, entering or leaving the electronic equipment input power terminals is not zero. These currents typically find alternate paths through the equipment chassis, 10 as shown in FIG. 2, and the application earth ground structure. These alternate and less predictable paths can be highly disruptive.

In addition to the noise currents that flow into and out of equipment power terminals, power producing currents, Is1 and Is2 as shown in FIG. 1 and FIG. 2, must also flow. The high frequency noise currents, both normal mode and common mode, essentially modulate the lower frequency power producing component. Power producing currents also flow in the normal mode. Inductors used in EMI Filters must pass the lower frequency power producing component and attenuate the high frequency noise currents.

FIG. 3 illustrates an inductor wound for normal mode attenuation with its electrical schematic symbol. FIG. 4 illustrates an inductor wound for common mode attenuation with its electrical schematic symbol. Equipment manufacturers have used the common mode inductor configuration shown in prior art FIG. 5 to achieve the required inductance and common mode attenuation. The configuration shown in FIG. 5 can be realized simply by adding more turns to the common mode inductor depicted in FIG. 4. Unfortunately, in high power applications, the number of turns wound on any inductor results in excessive and often time's unacceptable power loss. As the number of turns increases, power loss increases. A trade off must be made between the magnitude of the common mode inductance and power dissipation. To a certain degree, the inductance is fixed by the filter design requirements. With that in mind, the trade off is made between the relative permeability of the core material and the number of turns. In general, the relative permeability of the core will increase in direct proportion to the height of the core. Consequently, the trade off further decomposes into a trade off between core height vs. number of turns. In the limiting case in which power loss must be minimized at all cost, the number of turns becomes one for each power input connection as shown in FIG. 4. Increasing the height of the core or increasing the number of discrete cores can then achieve the required inductance. Further reductions in power dissipation can be achieved by optimizing the use of the winding area. An effective means of optimizing the winding is through the use of concentric windings that have the same shape as the magnetic core window area.

In order to meet the conducted emission requirements, inductive components are used in conjunction with capacitors in electrical networks referred to as Electromagnetic Interference (EMI) filters. EMI filters are highly effective in attenuating noise currents that emanate from electronic equipment. Noise currents can be characterized by the path that they take during conduction. Two conduction paths exist: Normal Mode (sometimes referred to as Differential Mode) and Common Mode. Normal mode noise currents flow into one input power terminal, of the electronic equipment, and exit from the remaining input power terminal(s). The sum of the all the normal mode noise currents entering and exiting the electronic equipment input power terminals is zero. In contrast, the sum of common mode noise currents entering or leaving the electronic equipment input power terminals is not zero. These currents typically find alternate paths through the equipment chassis, and the application earth ground structure. These alternate and less predictable paths can be highly disruptive.

In addition to the noise currents that flow into and out of equipment power terminals, power producing currents must also flow. The high frequency noise currents, both normal mode and common mode, essentially modulate the lower frequency power producing component. Power producing currents also flow in the normal mode. Inductors used in EMI Filters must pass the lower frequency power producing component and attenuate the high frequency noise currents.

Magnetic core materials are often used in the fabrication of inductors. Conductors are wound on the magnetic core material. It should be noted that the use herein of the terms “conductive”, “conductor”, and the like refer to electrical conductive properties. The magnetic core material concentrates the path of magnetic flux that is produced when current flows. This results in an increased level of induction, as compared to an air core inductor design. Unfortunately the ability of inductors that utilize magnetic core materials, to attenuate the high frequency noise currents can be diminished by the magnitude of the lower frequency power producing component. In essence, the lower frequency power producing component causes the inductor core material to saturate. When an inductor saturates its inductance and ability to attenuate has decreased to that of an air core inductor design. Inductors wound to attenuate normal mode noise currents are more susceptible to this effect because the normal mode power producing currents produce a net magnetic flux within the magnetic core. This flux by itself can saturate the inductor. When added to the flux produced by the normal mode high frequency noise currents, the saturation effect is enhanced. Inductors wound to attenuate common mode noise currents, are not affected by normal mode currents since the flux produced by normal mode currents sum to zero within the magnetic core. This allows the common mode inductor to support a large voltage-second product, produced by high frequency common mode currents, as well as a higher inductance when compared to an inductor wound for normal mode operation.

Equipment manufacturers have used the common mode inductor configuration of two multi-turn windings wound multi-filar to achieve the required inductance and common mode attenuation. Unfortunately, in high power applications, the number of turns wound on any inductor results in excessive and, oftentimes, unacceptable power loss. As the number of turns increases, power loss increases. A trade off must be made between the magnitude of the common mode inductance and power dissipation. To a certain degree, the inductance is fixed by the filter design requirements. With that in mind, the trade off is made between the relative permeability of the core material and the number of turns. In general, the relative permeability of the core will increase in direct proportion to the height of the core. Consequently, the trade off further decomposes into a trade off between core height vs. number of turns. In the limiting case in which power loss must be minimized at all cost, the number of turns becomes one for each power input connection. The required inductance can then be achieved by increasing the height of the core or increasing the number of discrete cores. Further reductions in power dissipation can be achieved by optimizing the use of the winding area. An effective means of optimizing the winding is through the use of concentric windings which have the same shape as the magnetic core window area.

Thus there is a need in the industry for an Inductor that is 1) low cost, 2) low loss of power, 3) will not saturate when passing DC (or low frequency) currents having large magnitudes, 4) easily configured, or integrated, into the next electronic assembly and 5) compact. The Inductor should incorporate multiple magnetic cores to increases magnetic induction, single turn windings for each line, and concentric windings shaped in the form of the magnetic core window area.

### SUMMARY OF THE INVENTION

The present invention substantially meets the aforementioned needs of the industry. The present invention is an Inductor that possesses the following feature: 1) low cost, 2) low loss of power, 3) will not saturate when passing DC (or low frequency) currents having large magnitudes, 4) easily configured, or integrated, into the next electronic assembly and 5) compact. Generally, an inductor is a current filtering device. The filter inductor resists changes in current by accumulating stored energy as an AC current crests each cycle and releases energy as the AC current minimizes in a cycle.

The Inductor of the invention represents a low cost solution when compared to the conventionally wound common mode inductors at equivalent power levels. The Inductor Invention uses readily available materials such as toroidal magnetic cores, brass or copper pipe, brass nuts, fiber washers and shrink tubing to realize the design. Assembly cost associated with applying isolated multiple turns wound in multi-filar fashion, as in the case of conventional designs, are avoided. In addition, testing cost used to verify inductance and resistance, as in the conventional common mode inductor designs, are also eliminated. Cost to integrate the Inductor Invention into the next assembly is also minimized. The brass pipe provides a window through which the wiring for the next assembly may be passed. Brass nuts at both ends provide convenient termination points for assembly wiring. The small power loss of the Inductor invention generates very limited heat and thereby eliminates the need for costly passive/active cooling schemes, as are required in conventional common mode inductor designs.

The Inductor Invention minimizes the power loss by using only one turn per power line input as well as concentric windings which mirror the magnetic core window area shape. The reduced power dissipation, as compared to conventional common mode inductor designs, enhances the reliability of the Inductor Invention. The Inductor Invention is wound to handle large power producing currents (these can be low frequency or DC) without saturating. Simple cradles act to provide support for the inductor which can be secured to the cradle with low cost tie wraps. In contrast, traditional common mode inductor designs must rely on more complex packaging schemes that must accommodate higher power dissipation levels and meet isolation requirements.

In addition, the higher power dissipation, associated with the conventionally wound common mode inductor, may increase the technical complexity of the cooling scheme for the assembly and system. The Inductor invention also simplifies the routing and termination of assembly wiring. The reduced power dissipation of this Invention also improves the reliability of the components used in next assembly by minimizing temperature rise within the assembly.

Finally, the Inductor Invention is as compact as conventionally wound common mode inductors. Techniques used to reduce the size of conventionally wound common mode inductors result in dramatic increases in power dissipation. This increases the size of the assembly and system cooling apparatus which destroys any gains in packaging density. Additionally, attempts made to reduce the size of a conventionally wound inductor result in substantial cost increases.

The present invention is an inductor, the inductor including an inductor assembly having two coaxial, substantially linear windings axially disposed with respect to a plurality of toroidal magnetic cores. The present invention is further a method of forming an inductor.

### BRIEF DESCRIPTION OF THE DRAWINGS

FIG. 1 is a schematic of electronic equipment with normal mode AC noise currents.

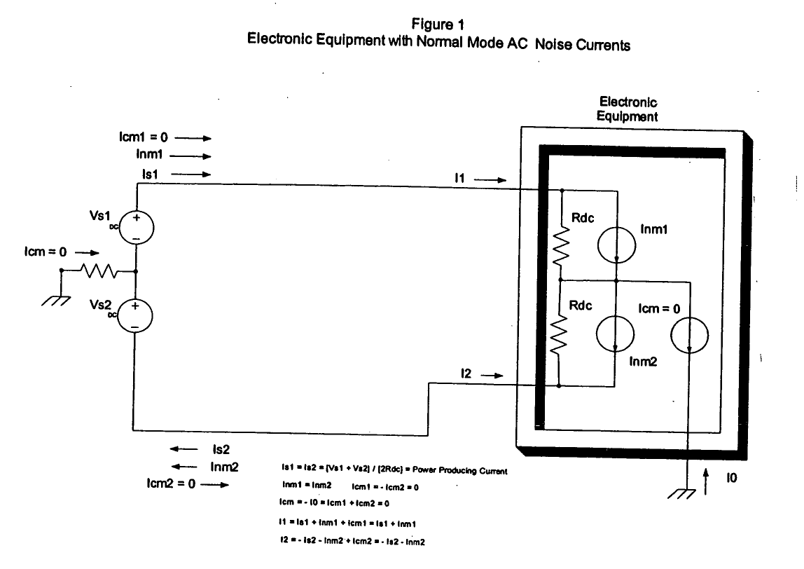

FIG. 2 is a schematic of electronic equipment with common mode AC noise currents.

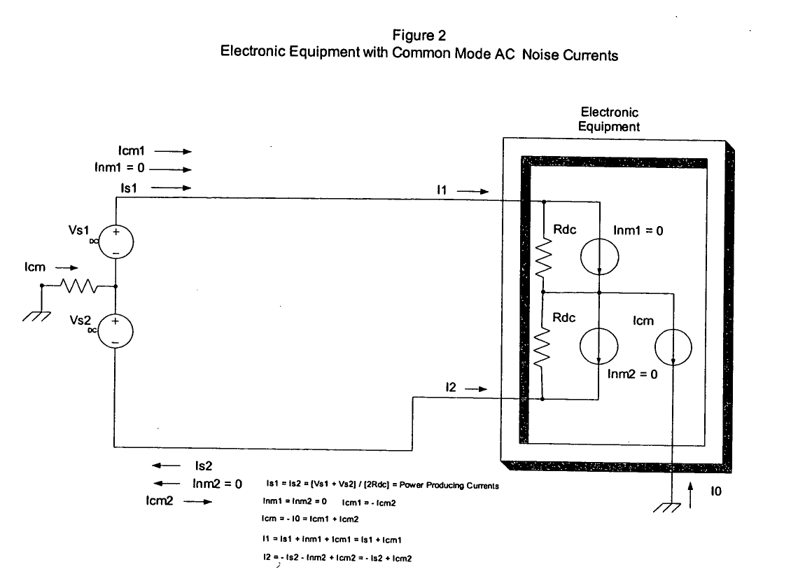

FIG. 3 is a schematic of an inductor wound to attenuate normal mode AC noise currents.

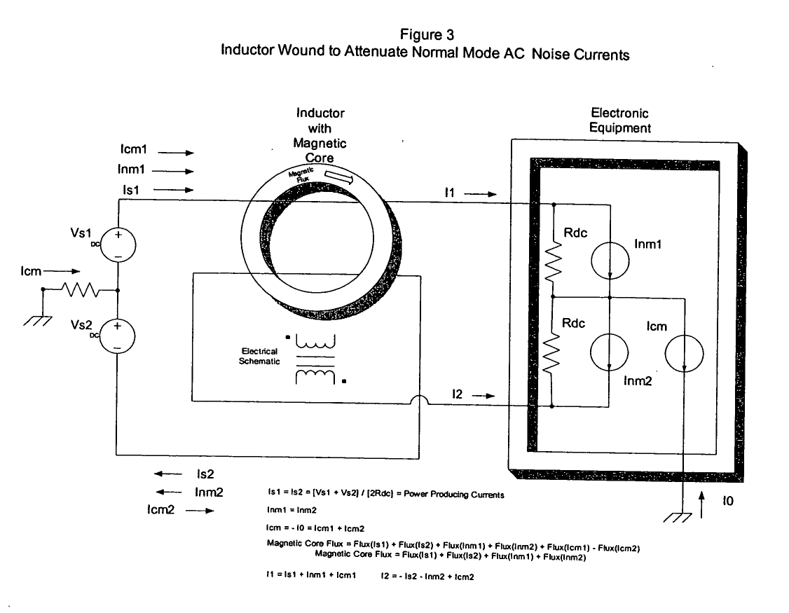

FIG. 4 is a schematic of an inductor wound to attenuate common mode AC noise currents.

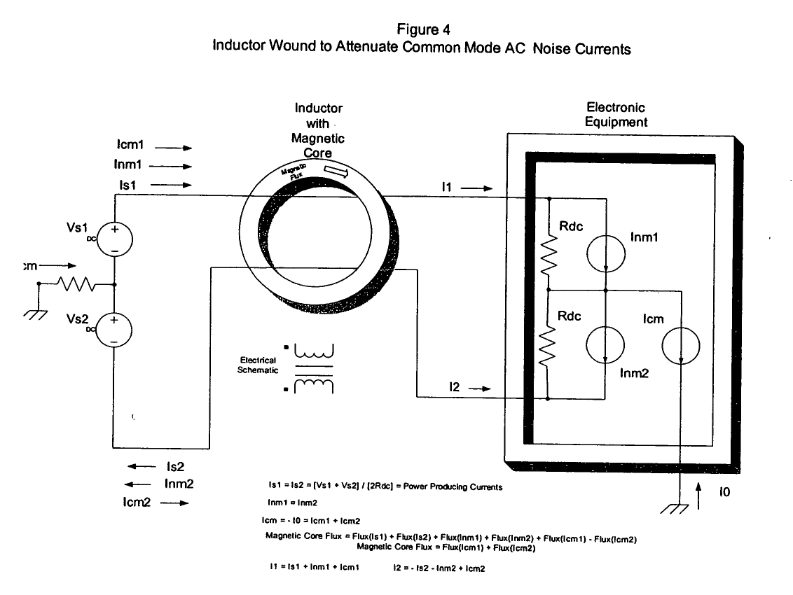

FIG. 5 is a prior art conventional common mode inductor with two three turn windings wound tri-filar and is a representative example of a conventional common mode inductor that has multiple turns and is wound multi-filar.

FIG. 6 is a perspective view of the present invention.

FIG. 7 is a component view of the Inductor of the present invention.

FIG. 8 is a perspective view of the Inductor invention as integrated into a three channel HPIU.

FIG. 9 is perspective view of a toroid with a schematically represented axial conductor.

### DETAILED DESCRIPTION OF THE DRAWINGS

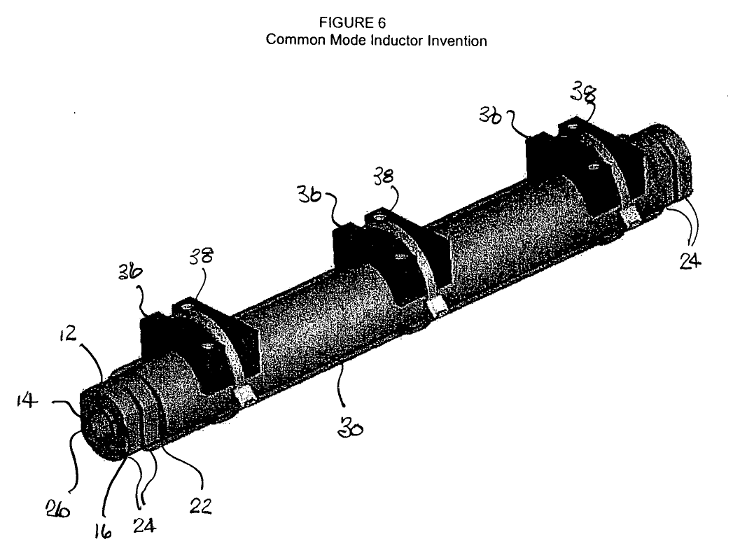

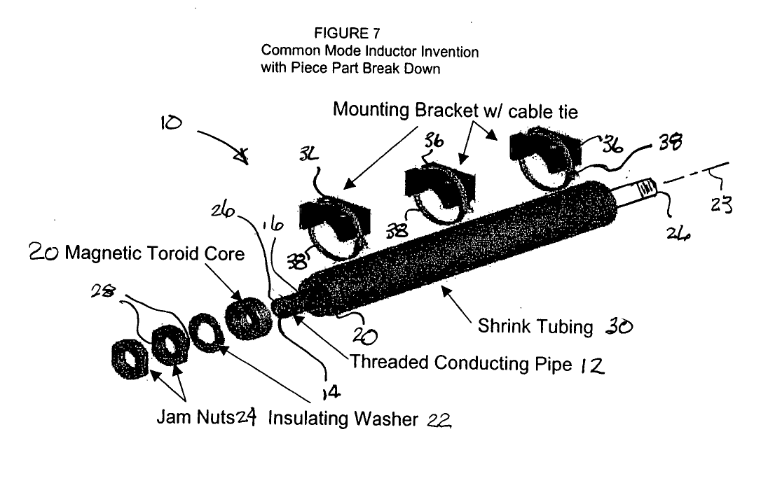

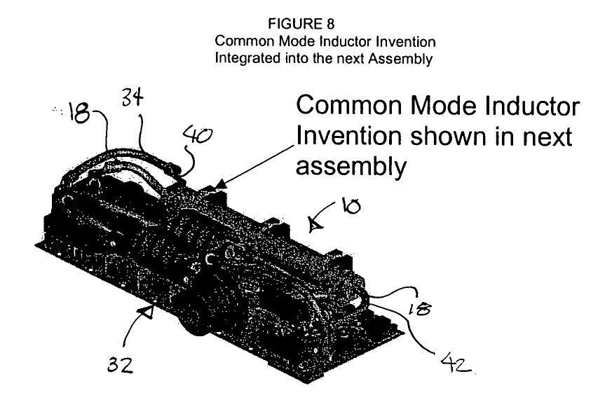

The Inductor of the present invention is shown generally at 10 in the Figures. FIG. 6 depicts the inductor 10 generally and incorporates the following design techniques: 1) Multiple magnetic cores to increases magnetic induction, 2) Single turn windings for each line and 3) Concentric windings shaped in the form of the magnetic core window area. FIG. 7 depicts the Inductor Invention with piece parts identified. FIG. 8 shows the inductor 10 integrated into the next assembly.

The technical design requirements for a first embodiment of the inductor 10 shown in FIG. 7 and FIG. 8 are:
Loc (each winding)=96.6 μH @ Frequency=10 kHz, B=10 gauss.
I_{Rated}=80 Amps
Pd=3.2 W @ I_{Rated}
Z_{CM}=500Ω Angle 0 degrees @ Frequency=3.5 MHz
Dielectric With Stand Voltage=2000 Vrms @ Frequency=60 Hz for 1 minute
Insulation Resistance=100 MΩ @ 600 V

The threaded conductive pipe 12 has an axial bore 14 that extends through the full length of the pipe 12 and is open at both ends thereof. The threaded conductive pipe 12 provides support for the toroidal magnetic cores on the cylindrical exterior margin 16 thereof. The threaded conductive pipe 12 is further the conductor for one axial winding. The threaded conductive pipe 12 is preferably being formed of brass, but other conductive materials are suitable as well.

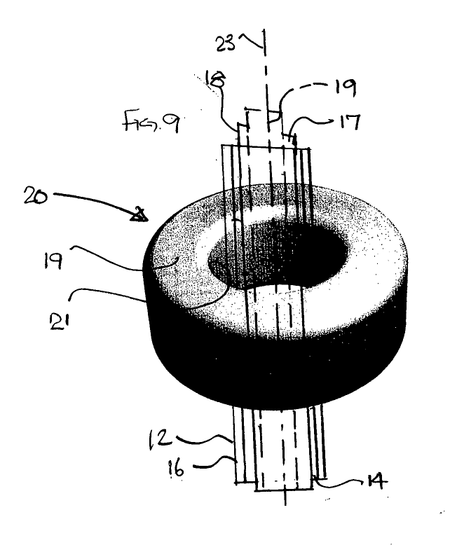

The inner diameter (I.D.) of the axial bore 14 of the threaded conductive brass pipe 12 is sized to support an insulated conductor 18 (see FIGS. 8 and 9) having a circular mil area to current ratio of 500 cm/A, the insulated conductor 18 being a second axial winding. The insulated conductor 18 is preferably disposed substantially coaxially with the pipe 12.

The outer diameter (O.D.) of the cylindrical exterior margin 16 of the threaded conductive pipe 12 is selected based on the material thickness necessary to support the mechanical threads at either end thereof and the 500 cm/A ratio (ratio of the area in circular mils to current in Amperes). The 500 cm/A ratio results in low power dissipation and is consistent with design guidelines used to select conductors for magnetic components.

A plurality of toroidal magnetic cores 20 are slid over the threaded conductive pipe 12. The magnetic cores 20 are disposed adjacent one another on the pipe 12 and preferably, adjacent magnetic cores 20 abut one another. The number of toroidal magnetic cores 20 employed depends on Loc (Open Circuit Inductance) and the permeability of the core material. In a preferred embodiment, there may be ten to thirty such toroidal magnetic cores 20 and preferably about twenty such toroidal magnetic cores 20 mounted in a side-by-side array on the pipe 12. The toroidal magnetic cores 20 may be either bare or coated. Coatings may include Parylene C (Parylene is a trademark of Union-carbide Corp.), grey coating, or black lacquer. Grey coating may include polyester or nylon.

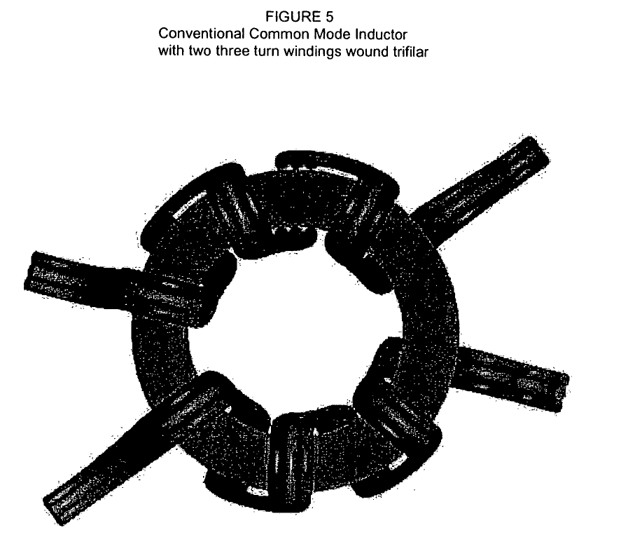

It should be noted that the toroidal magnetic cores 20 are not wound in the conventional manner depicted in the prior art FIG. 5. The “windings” of the present invention do not actually wind around or encircle any portion of the toroid wall 19 of the toroid 20, as is conventionally done and as depicted in prior art FIG. 5. The two windings of the present invention are substantially coaxially disposed and comprise the concentric threaded conductive pipe 12 (of FIG. 7 and 9) and the axial insulated conductor 18 (of FIGS. 8 and 9) that is passed axially through the bore 14 of threaded conductive pipe 12. The axial insulated conductor 18 includes an axial conductor 15 that is circumferentially covered with an insulating material 17, as noted in FIG. 9. The insulating material 17 electrically isolates the axial conductor 15 from the pipe 12.

The toroid 20 of FIG. 9 has a closed toroidal wall 19, defining an interior circular bore 21 having a transverse axis 23. The transverse axis 23 is preferably coincident with the longitudinal axis 23 of the pipe 12 when a selected toroid 20 is disposed on the pipe 12. As noted above, the toroidal wall 19 is not wound in the conventional manner. The two conductors 12, 18 noted above are passed axially through the bore 21 and the circular cross sectional shape of the two conductors 12, 18 mirror the circular shape of the bore 21. Specifically, the bore 21 is circular, the exterior margin 16 of the pipe 12 is cylindrical, and the exterior margin of the insulated conductor 18 is cylindrical.

The toroidal magnetic cores 20 are held in placed by an insulating fiber washer 22 and a pair of jam nuts 24 at each end 26 of the threaded conductive brass pipe. This is depicted in FIG. 7 and it should be noted that each end of the inductor 10 is identical, having an identical array of jam nuts 24 and insulating washers 22 as depicted in FIG. 7. The insulating fiber washer 22 is preferably made of fiber glass. The jam nuts 24 are preferably made of brass. The jam nuts 24 preferably have a pair of opposed flats 28 defined on the exterior margin thereof in order to provide purchase for a tool, such as a wrench. In assembly, the jam nuts are loosely added at each end 26 of the pipe 12 so that that the jam nuts 24 can be readily removed when the inductor 10 is added to the next assembly 32 (an electrical assembly as seen in FIG. 8) for use in securing the assembly wiring 34 to the threaded conductive brass pipe 12 when the inductor 10 is integrated into the assembly 32.

Shrink tubing 30 is applied over the toroidal magnetic cores 20 after the toroidal magnetic cores 20 are mounted on the pipe 12. Heating of the shrink tubing 30 after the tubing 30 is slipped over the plurality of cores 20 acts to shrink the tubing 30 into compressive engagement with the cores 20 and serves to hold the cores 20 firmly in place on the pipe 12. The ends of the shrink tubing 30 are rolled over the outward directed side margin of the respective toroidal magnetic cores 20 occupying the two opposed end positions of the array of the plurality of adjacent toroidal magnetic cores 20 in order to further capture the toroidal magnetic cores 20.

A plurality of cradles 36 are loosely fitted to the inductor 10 during assembly by means of tie wraps 38, thereby allowing the cradles 36 to be adjusted both rotationally and axially with respect to the shrink tubing 30 as needed at the time of integration into the next assembly 32. Assembly wiring 38 is preferably conductively attached to the threaded pipe 12 using crimp lugs 40 with a 90 degree bend. Conductive wiring 18 for the second winding is inserted through the axial bore 14 in the threaded conductive brass pipe 12 and then terminated to the next assembly 32.

Source inspection of the inductor 10 piece part suppliers, a very simple and straight forward assembly process, and initial inductor 10 qualification testing results in a minimal set of conformance test requirements for the inductor 10. Conformance Testing/Inspection consists of a visual inspection in which the desired number of cores 20 in the array on the pipe 12 is verified. Insulation Resistance testing at the assembly level verifies assembly level and inductor 10 wiring in one step.

Fabrication of the inductor 10 includes the following steps:
1. Using red brass tubing and round stock, fabricate one threaded pipe 12 and four jam nuts 24 per unit.
2. Dispose preferably about twenty each XJ42508-TC toroidal magnetic cores 20 on the pipe 12 and encapsulate the toroidal cores 20 in heat shrink tubing 30, rolling the ends of the shrink tubing 30 to capture the toroidal cores 20.
3. Fabricate mounting cradles 36 from 6061-T551 aluminum and mount to the shrink tubing 30 with tie wraps 38.
4. Dispose the insulated conductor 18 in the bore 14 of the pipe 12.

The inductor 10 may then be physically mounted on the next assembly 32 by means of the mounting cradles 36 and separate electrical connection of the insulated conductor 18 and of the pipe 12 (effected by means of assembly wiring 38) may be made to the next assembly 32.

Those skilled in the art will appreciate that numerous modifications can be made without departing from the spirit of the present invention.

1. An inductor, comprising:
an inductor assembly having at least one power line input having no more than one turn per power line input; and
at least one concentric winding, the at least one concentric winding having a shape, the shape mirroring a magnetic core bore shape for minimizing power loss.

2. The inductor of claim 1 having a first winding being a conductive pipe.

3. The inductor of claim 2 having a second winding being a conductor disposed axially in an axial bore defined in the pipe.

4. The inductor of claim 2, the pipe having a first and a second end and having connecting means for connecting a conductor proximate the first and second ends.

5. The inductor of claim 3, the second winding being conductively terminable to an electrical assembly.

6. The inductor of claim 1, the inductor assembly including an array comprising a plurality of toroidal magnetic cores, each toroidal core having a circular bore defined therein, a conductive pipe being disposed in the circular bore of each toroidal core of the plurality of toroidal cores.

7. The inductor of claim 6 having between ten and thirty toroidal cores.

8. The inductor of claim 7 having twenty toroidal cores.

9. The inductor of claim 6, the plurality of toroidal cores being captured on the pipe by means of a circumferential shrink wrap.

10. The inductor of claim 6, each of the toroidal cores in the array having a closed toroidal wall wherein none of the plurality of toroidal cores has any portion of a respective toroidal wall encircled by a winding.

11. An inductor, comprising:
an inductor assembly having two coaxial, substantially linear windings axially disposed with respect to a plurality of toroidal magnetic cores.

12. The inductor of claim 11 having a first winding of the two coaxial, substantially linear windings being a conductive pipe.

13. The inductor of claim 12 having a second winding of the two coaxial, substantially linear windings being a conductor disposed axially in an axial bore defined in the pipe.

14. The inductor of claim 11, the two coaxial, substantially linear windings being coaxially disposed and not physically in electrical communication.

15. The inductor of claim 11, the cross sectional shapes of the two coaxial, substantially linear windings mirroring the shape a bore defined in each of the respective toroidal cores.

16. A method of forming an inductor, comprising:
disposing a plurality of toroidal magnetic cores in an array on a conductive pipe;
encapsulating the toroidal magnetic cores in heat shrink tubing to capture the toroidal cores; and
disposing an insulated conductor in an axial bore defined in the pipe.

17. The method of claim 16, including fabricating mounting cradles and mounting the cradles to the shrink tubing.

18. The method of claim 16 including disposing the conductive pipe and the insulated conductor with respect to one another to form two coaxial, substantially linear windings.

19. The method of claim 18 including forming the two coaxial, substantially linear windings to mirror the shape a bore defined in each of the respective toroidal magnetic cores.

20. The method of claim 16 including forming each of the toroidal magnetic cores in the array with a closed toroidal wall and not encircling any portion of a respective toroidal wall by a winding.
